(19) United States
(12) Patent Application Publication
(10) Pub. No.: US 2003/0217650 A1
(43) Pub. Date: Nov. 27, 2003

(54) Apparatus and method for harvesting and coring produce

(76) Inventor: Enemesio R. Herrera, Santa Maria, CA (US)

Correspondence Address: SINSHEIMER, SCHIEBELHUT & BAGGETT, 1010 Peach Street, Post Office Box 31, San Luis Obispo, CA, 93406, US

(21) Appl. No.: 10/154,537

(22) Filed: May 23, 2002

(51) Int. Cl. A23N 4/12

(52) U.S. Cl. 99/547; 56/122

(57) ABSTRACT

The present invention provides an apparatus and method for harvesting and processing produce including a produce seat having a cutter aperture, wherein the produce seat receives produce such that the produce is aligned with a cutter. The cutter is secured with a shaft that is rotationally coupled with a motor configured to rotate the shaft and cutter. A support is configured to position the produce seat proximate the cutter and the support is configured to allow the produce seat to be moved from a first position where the produce seat is proximate the cutter, to a second position such that at least a portion of the cutter extends through the cutter aperture, and to allow the produce seat to be returned to the first position.

### BACKGROUND OF THE INVENTION

1. Field of the Invention

The present invention relates generally to produce harvesting, and more specifically to harvesting and preparing produce for shipment.

2. Discussion of the Related Art

Produce is often damaged during harvesting and during preparation for shipment. For example, some produce such as cauliflower, lettuce, cabbage, and other such produce are cored following harvesting in preparation for shipment. Many previous coring devices require an individual to manually core the produce. One example of a previous coring device is a coring ring. In use, a coring ring is forced into the produce, generally hammered into the produce in order to achieve a desired penetration. This often causes damage and is not accurate. Typically, the produce is set onto a hard surface while the coring ring is slammed into the produce. The hard surface most often causes bruising and damage to the produce.

### SUMMARY OF THE INVENTION

The present invention advantageously addresses the needs above as well as other needs by providing an apparatus and method for harvesting and processing produce. In one embodiment, the invention can be characterized as an apparatus for coring produce having a produce seat having a cutter aperture, wherein the produce seat is configured to receive produce to be cored such that the portion of the produce to be cored is positioned and aligned with the cutter aperture; a cutter is secured with a shaft, the shaft being rotationally coupled with a motor configured to cause the shaft and cutter to rotate, wherein the cutter is aligned with the cutter aperture; and a support being configured to position the produce seat such that the produce seat is positioned proximate the cutter and the cutter aperture is aligned with the cutter, wherein the support is configured to allow the produce seat to be moved from a first position where the produce seat is proximate the cutter, to a second position such that at least a portion of the cutter extends through the cutter aperture, and to allow the produce seat to be returned to the first position.

In another embodiment, the invention can be characterized as an apparatus for processing harvested produce having a motor rotationally coupled with a shaft at a first end of the shaft; a cutter being secured to a second end of the shaft such that the cutter rotates as the shaft rotates; a produce seat having a cutter aperture, wherein the produce seat is movable along an axis such that in a first position the produce seat is proximate the cutter and the cutter does not extend through the cutter aperture, and in a second position the cutter at least partially extends through the cutter aperture.

In another embodiment, the invention can be characterized as a harvesting vehicle for harvesting produce, where the vehicle includes a frame supported by one or more movement devices, wherein the frame provides rigidity and structure to the harvesting vehicle; one or more processing stations having a coring apparatus, wherein the coring apparatus comprises: a produce seat having a cutter aperture, where in the produce seat is configured to receive produce such that a portion of the produce to be cored is aligned with the cutting aperture; a cutter aligned with the cutter aperture; and one or more supports configured to provide positioning of the produce seat, such that in a first position the cutter does not extend through the cutter aperture and in a second position the cutter extends at least partially through the cutter aperture.

In another embodiment, the invention can be characterized as a method for coring produce. The method for coring produce comprising the steps of positioning the produce in a produce seat; aligning the produce with a cutter aperture of the produce seat; forcing the produce seat and produce towards the cutter; causing the cutter to contact the produce; continuing to force the produce onto the cutter until a desired penetration of the cutter into the produce is achieved providing a cored produce; forcing the cored produce away from the cutter; and removing the cored produce from the produce seat.

In another embodiment, the invention can be characterized as an n apparatus for processing harvested produce. The apparatus includes means for receiving and maintaining produce, the means for receiving and maintaining the produce including an aperture; means for cutting aligned with the aperture; means for rotating being secured with the means for cutting, such that the means for rotating rotates the means for cutting; means for supporting the means for receiving and maintaining the produce, wherein the means for supporting allow movement of the means for receiving and maintaining such that in a first position the means for cutting is not protruding through the aperture, and in a second position the means for cutting at least partially extends through the aperture; and means for resisting movement of the means for receiving and maintaining from the first position to the second position.

A better understanding of the features and advantages of the present invention will be obtained by reference to the following detailed description of the invention and accompanying drawings that set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a cross-sectional view of a simplified block diagram of an apparatus for coring produce in a first position;

FIG. 2 depicts a cross-sectional view of the apparatus shown in FIG. 1 in a second position;

FIG. 3 depicts a cross-sectional view of an apparatus according to one embodiment of the present invention for coring produce;

FIG. 4 shows a simplified block diagram of an elevated view of a produce seat according to one embodiment of the present invention;

FIG. 5 depicts a cross-sectional view of the produce seat shown in FIG. 4;

FIG. 6 depicts a simplified elevated view of one embodiment of a press plate;

FIG. 7 shows an elevated view of one embodiment of a cutter guard;

FIG. 8 shows an elevated side view the cutter guard shown in FIG. 7;

FIG. 9 shows an elevated view of a support plate according to one embodiment of the present invention;

FIG. 10 depicts a simplified elevated view of a housing lid according to one embodiment;

FIG. 11 depicts a simplified elevated view of one embodiment of a base support plate;

FIG. 12 shows a simplified cross-sectional view of a support according to one embodiment of the present invention;

FIG. 13 depicts an elevated view of one implementation of a cutter according to one embodiment of the present invention;

FIG. 14 depicts a simplified block diagram of an elevated perpendicular view of the cutter shown in FIG. 13;

FIG. 15 shows a cross-sectional view of a base of a mounting post of the cutter shown in FIGS. 13 and 14;

FIG. 16 depicts a plain view of an extension shaft according to one embodiment of the present invention;

FIG. 17 shows one embodiment of a cross-sectional view of the extension shaft;

FIG. 18 depicts a simplified flow diagram of a process for harvesting and preparing produce for shipment;

FIG. 19 depicts an elevated view of an agricultural harvesting vehicle according to one embodiment of the present invention;

FIG. 20 depicts a cross-sectional view of the agricultural harvesting vehicle shown in FIG. 19;

FIG. 21 depicts an elevated view of a harvesting vehicle 580 according to one embodiment of the present invention;

FIGS. 22, 23 and 24 depict a cross-sectional view along an axis, a rear elevated view and a side elevated view, respectively, of the harvesting vehicle shown in FIG. 21;

FIGS. 25 and 26 depict an elevated view and a cross-sectional view, respectively, of a harvesting vehicle according to one embodiment of the present invention; and

FIGS. 27-29 show an elevated view, cross-sectional view and a rear view, respectively, of a harvesting apparatus according to one embodiment of the present invention.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention. The scope of the invention should be determined with reference to the claims.

The present invention provides for a method and apparatus for harvesting and preparing produce for shipment. The method and apparatus provide for the removal of a core from harvested produce or products while still in the fields. The removal of the core while still in the fields during harvesting limits how much the produce needs to be handled in processing and preparing the produce for shipment and reduces the amount of damage to the produce. Thus, the present invention delivers a higher quality of produce.

The present invention provides for additional processing while in the fields to prepare the produce for shipment. In one embodiment, the present apparatus and method provide for cleaning of the produce while still in the fields. The present invention allows for the cleaning prior to or following the coring. The cored and cleaned produce is then packaged and ready for shipment.

In one embodiment, the present apparatus and method are implemented within a produce processing plant. The produce is cored during processing and packaging. Additionally, the produce is washed and packaged for shipment.

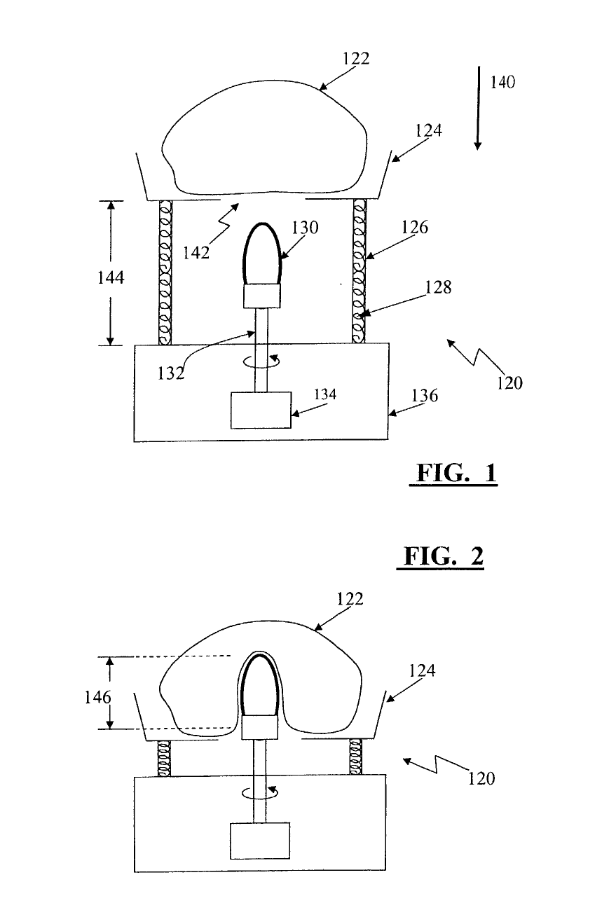

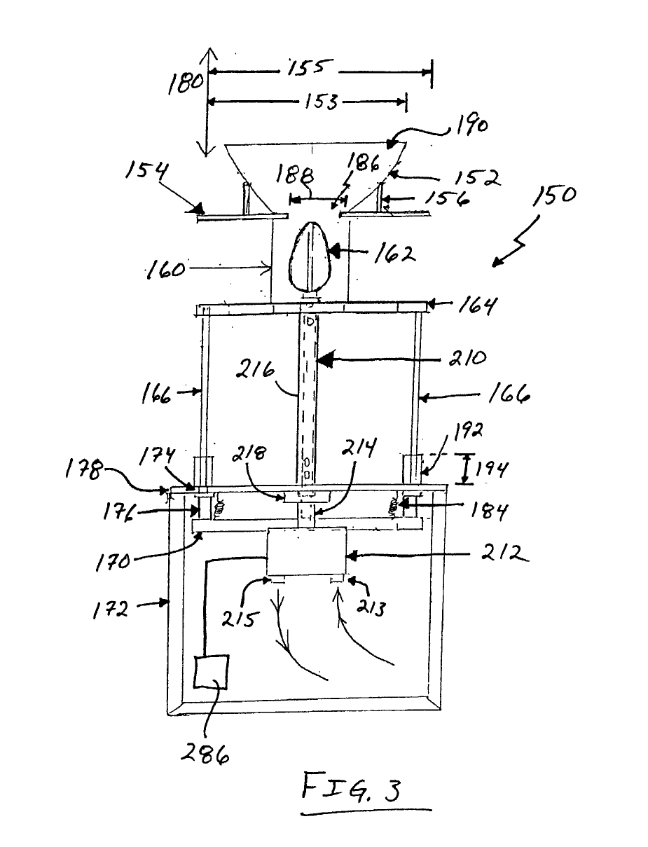

FIGS. 1 and 2 depict a cross-sectional view of a simplified block diagram of an apparatus 120 for coring produce according to one embodiment of the present invention. A product or produce 122 is received in a produce seat or mount 124. The produce seat 124 is supported by one or more supports 126 above a cutting device 130, such as blade, a plurality of blades or other such devices.

The cutting device 130 is secured to a shaft 132 at a first end of the shaft. A second end of the shaft 132 is secured to a motor 134. The motor is configured to rotate the shaft 132 and thus the cutting device 130. In one embodiment, the motor is secured within a housing 136. The motor 134 can be substantially any type of motor capable of rotating the shaft 132 and cutting device 130 including electrical, hydraulic, mechanical, pneumatic and substantially any other motor. The produce seat 124 includes an aperture 142. The aperture 142 has a width or diameter greater than the width or diameter of the rotation of the cutting device 130.

FIG. 1 shows the apparatus 120 with the produce seat 124 in a first position such that the produce 122 is not in contact with the cutting device 130. FIG. 2 shows the apparatus with the produce seat 124 in a second position with the cutting device extending through the aperture 142 penetrating into the produce 122. In operation, the produce 122 is initially positioned in the produce seat 124. While the motor 134 is active and rotating the cutting device 130, the produce 122 and produce seat 124 are moved towards the cutting device along the axis 140. The produce 122 is forced onto the rotating cutting device such that the cutting device pierces the produce 122 and begins to cut out a portion of the produce. The produce and produce seat are forced along an axis 140 until the cutting device 130 has penetrated into the produce to a desired depth or the produce seat 124 and produce 122 cannot be forces further along the axis 140. The produce 122 and produce seat 124 are then returned to the first position such that the produce 122 is not in contact with the cutting device 130. In one embodiment, the apparatus 120 further includes one or more compression resistance devices 128 configured to resist movement of the produce seat 122 in the direction towards the cutting device 130, along an axis 140. Upon release of pressure, the compression resistance devices 128 begin to force the produce seat back to the first position. Thus, the cutting device has cut out a portion of the produce, preferably the core of the produce.

The cutting device 130 can be of any size such that the rotational width or diameter of the cutting device is sufficiently large to remove the desired amount of the produce to remove the core. Further, the height or distance 144 along the axis 140 that the produce seat 124 and the produce 122 can be moved can be of substantially any length so that the cutting device 130 penetrates into the produce 122 to a desired depth 146 within the produce 122 (see FIG. 2).

FIG. 3 depicts a cross-sectional view of an apparatus 150 according to one embodiment of the present invention for coring produce. The apparatus 150 includes a produce seat 152 that receives produce to be cored. In one embodiment, the produce seat 152 is concaved to aid in maintaining the position of the produce within the seat 152 during coring. The produce seat 152 is mounted on a press plate 154. In one embodiment, one or more seat supports 156 are secured between the produce seat 152 and the press plate 154 to provide increased rigidity and stability.

The press plate typically is configured to have a width or diameter 155 that exceeds a width or diameter 153 of the produce seat 152. This allows an operator of the apparatus 150 to easily access and apply pressure on the press plate 154 to push or force the press plate and produce seat, and thus the produce within the produce seat, towards a cutter 162.

The press plate is secured to a cutter guard 160. The cutter guard provides support and positioning for the produce seat 152. In one embodiment, the cutter guard 160 at least partially surrounds or covers the cutter 162. The cutter can be one or more blades or other structures capable of cutting a selected produce. The cutter guard 160 provides safety to protect operators of the apparatus 150 from the cutter 162 and protects the cutter from damage. In one embodiment, the cutter guard is simply one or more beams or rods distributed about the cutter to support the produce seat 152. The cutter guard is further secured to a support plate 164. One or more supports 166 are secured between the support plate and a base support plate 170. In one embodiment, the cutter guard is formed by the supports. In this embodiment, the support plate is not utilized and the supports extend between the base support plate 170 and the produce seat 152 and/or press plate 154.

The base support plate 170 is positioned within a housing 172. The supports 166 pass through one or more support apertures 174 of a lid 178 of the housing 172. The supports are additionally axially aligned with and pass through linear motion flanges 176. In embodiment, the support apertures 174 and motion flanges 176 are such that the supports 166 freely move through the support apertures and motion flanges along a first axis 180 of the supports. The linear motion flanges 176 aid in maintaining the stability of the supports 166 and maintaining the linear direction of motion of the supports along the first axis 180. The support apertures 174, motion flanges 176, the base support plate 170 and the support plate 164 maintain the position of the produce seat 152 relative to the cutter 162 to stabilize and maintain the positioning of the produce during coring. In one embodiment, the supports and support plate and/or the base support plate are a single continuous piece. One or more expansion resistance devices and/or compression resistant devices 184 are included to resist the movement of the support plate 164, and thus the produce seat 152 and produce, along the first axis 180 towards the housing 172. In one embodiment, expansion resistance devices 184 are secured between the lid 178 of the housing and the base support plate 170. As the produce seat 152 is forced towards the housing 172 the base support plate 170 is forced away from the lid 178 expanding the expansion resistance devices 184.

Upon reduction or release of the force pushing the produce seat towards the housing, the expansion resistance devices 184 forces the base support plate 170 back towards the lid 178, and thus forcing the produce seat 152 away from the housing 172. The expansion (or/and compression) resistance devices 184 can be substantially any expansion and/or compression resistance device including springs, hydraulics and substantially any other expansion or/and compression resistant device. In one embodiment, the extension resistance devices can be configured to limit the rate at which the produce seat and produce return to a first starting position where the cutting device is not penetrating the cutter aperture 186. Alternatively, the apparatus 150 includes dampeners that reduce or limit the rate at which the produce seat returns to the first position.

The cutter 162 is secured to a shaft 210. The shaft extends away from the cutter 162 and produce seat 152 extends through the support plate 164 and the lid 178, and is secured with a motor 212. The motor is configured to rotate the shaft 210 causing the cutter to rotate. The motor can be substantially any type of motor. In one embodiment, the motor is a hydraulic motor and includes a hydraulic fluid input port 213 and output port 215. The rotational speed of the shaft 210 and cutter 162 can be a single speed or be controlled by substantially any control including, manual, feedback through a processor and other such controls.

In one embodiment, the shaft 210 includes a motor shaft 214 and a shaft extension 216. The motor shaft 214 is secured with the motor 212 and is rotated by the motor. The extension shaft 216 is secured with the motor shaft and extends through the lid 178 and support plate 164 to be attached with and rotate the cutter 162.

In one embodiment, the apparatus 150 includes a shaft bearing and/or seal 218. The shaft bearing/seal is secured to the lid 178 and includes an aperture (not shown) to allow the shaft 210 to extend through the shaft bearing/seal. The aperture of shaft bearing/seal 218 is configured to have a diameter or width that is just larger than the diameter or width of the shaft such that the bearing is in contact with the shaft. The bear rotates as the shaft rotates. The bearing/seal 218 aids in preventing debris, such as dust, dirt, produce cuttings and other debris, from entering the housing 172 and provides added stability to the shaft 210.

The produce seat 152 and press plate 154 include corresponding and aligned cutter apertures 186. The cutter aperture is typically configured to have a width or diameter 188 greater than a width or rotational diameter 334 (see FIG. 13) of the cutter 162. As such, when a force is applied to the press plate 154 and/or produce seat 152 towards the cutter, the produce seat moves along the first axis 180 so that at least a portion of the cutter 152 extends up into a cavity 190 of the produce seat.

In one embodiment, the apparatus 150 includes one or more stops 192. The stops are positioned to halt the movement of the produce seat 152 and press plate 154 along the first axis 180 towards the housing 172. This prevents further penetration of the cutter 152 into the cavity 190 of the produce seat, and thus the produce positioned within the seat during operation. In one embodiment, the stops 192 are adjustable to allow any number of lengths 194 to control the penetration of the cutter 152 into the cavity 190.

The stops 192 can be positioned in substantially any position to stop movement, including on or around one or more supports 166, attached to the press plate 154, attached with the lid 178, within the housing to contact the base support plate 170 or other such positioning to halt the movement of the produce seat 152. The adjustment of the stops can be provided through substantially any number of ways including adding or removing segments of the stop 192, telescoping of the stops, thread screwing along the supports 166 and substantially any other means for adjusting.

In one embodiment, the stops 192 are one or more sleeves or partial sleeves positioned around and axially aligned with a support. The support plate moves along the first axis 180 towards the housing 172 until the support plate 164 contacts the stops halting the movement of the produce seat and produce. The partial sleeves include longitudinal grooves along a length allowing sleeves to be added or removed from about the supports without disassembly of the apparatus. As one example, the stop sleeves can be in contact with the lid and thus limit the movement of the seat when the support plate contacts the stop sleeves. A plurality of sleeves stacked together can be employed to provide a desired range of motion for the seat along the first axis 180 and thus a desired penetration of the cutter into the produce.

In one embodiment, the stops can be thread screwed onto the supports proximate the support plate 164. The stops can be screwed away from the support plate to limit the range of motion or screwed towards the support plate to enlarge the range of motion.

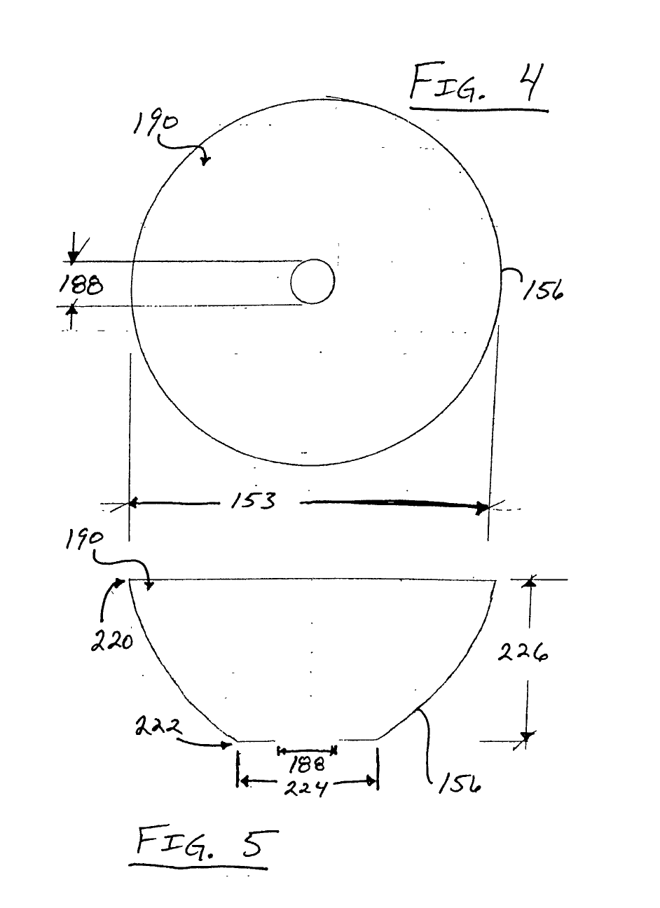

FIG. 4 shows a simplified block diagram of an elevated view of the produce seat 156 and FIG. 5 depicts a cross-sectional view of the produce seat 156 according to one embodiment of the present invention. In one embodiment, the produce seat is concaved to aid in maintaining positioning of the produce within the seat 156 during coring. In one embodiment, the produce seat is bowl shaped having a generally tapering cylindrical shape that tapers from an open portion 220 to a base 222. The open portion has a diameter 153 that is sufficiently large to receive produce. Typically the diameter 153 is selected to be at most greater than the diameter of the produce harvested by 140%. Further, the diameter should not less than 98% of the produce being harvested. In one embodiment, the produce seat 156 is detachable, allowing any number of different sized produce seats to be incorporated into the apparatus 150. The cavity 190 of the produce seat 152 has a depth 226 that is sufficiently deep to receive and maintain a produce within the seat. The produce seat 152 shown in FIGS. 4 and 5 has a cylindrical shape, however, it will be apparent to those skilled in the art that substantially any shape can be utilized that receives and aids in maintaining produce within the seat 152, such as cubical, oval, pyramid, octagonal and other such shapes.

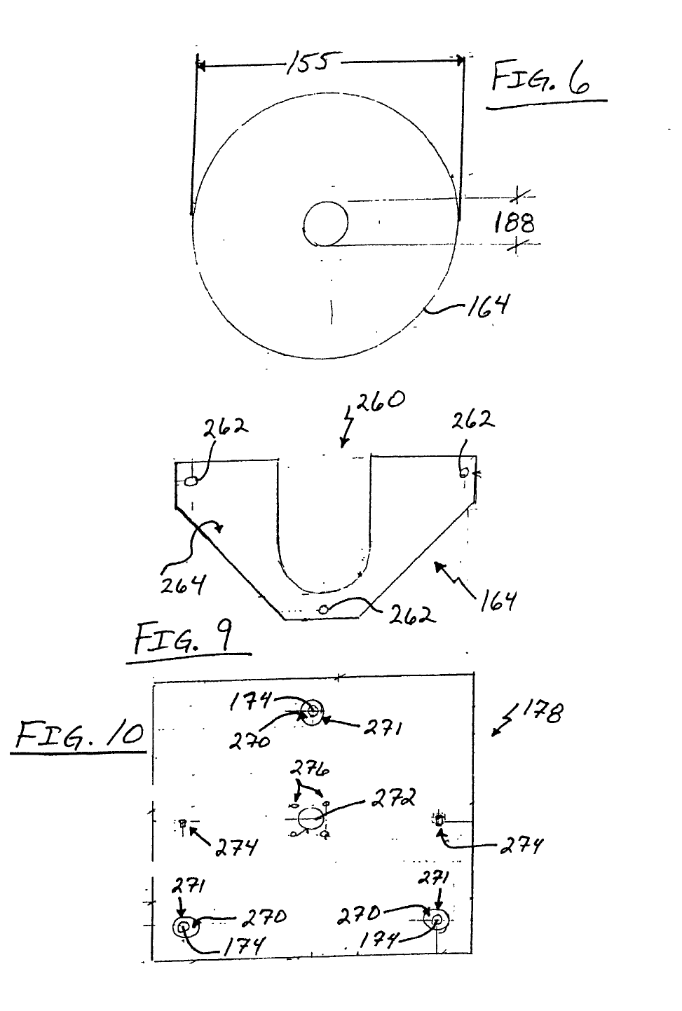

FIG. 6 depicts a simplified elevated view of one embodiment of the press plate 154. The press plate includes the cutter aperture 188 that is greater than the width or rotational diameter of the cutter 334 (see FIG. 13). Additionally, as described above, the width or diameter 155 of the press plate is typically greater than the diameter 153 of the produce seat 152. This allows a user of the apparatus 150 to easily access the press plate in order to apply pressure to the press plate forcing the produce seat 152 over cutter 162 and thus the produce within the seat onto the cutter 162. The press plate 154 shown in FIG. 6 has a round shape. However, it will be apparent to one skilled in the art that the press plate can have substantially any shape including generally triangular, square, rectangular, oval and substantially any shape.

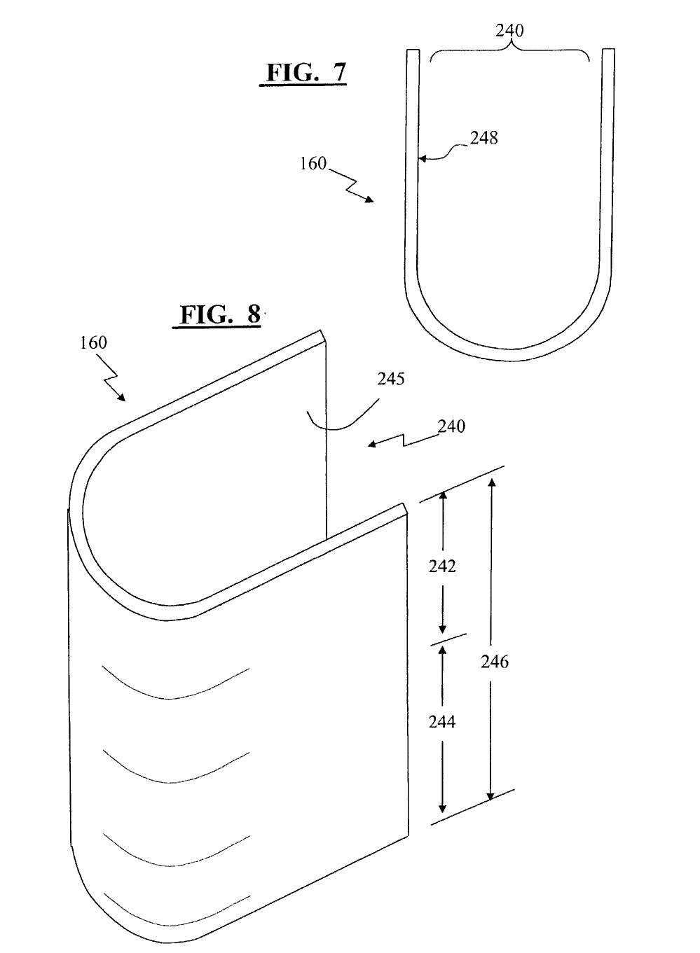

FIG. 7 shows an elevated view and FIG. 8 shows an elevated side view of one embodiment of the cutter guard 160. In the embodiment of the cutter guard shown in FIGS. 7-8, the cutter guard has generally a “U” shape. The mouth 240 of the cutter guard is passed around the cutter 162 and shaft 210, and the cutter and shaft are position within the cutter guard to provide protection from and for the cutter 162. In one embodiment, the cutter guard does not completely surround the cutter and shaft. In stead, a gap, defined by the mouth 240 of the generally “U” shaped cutter guard 160 is open. This allows cutting from the produce being cored to be removed while the apparatus 150 is in operation. As such, the apparatus 150 can be continuously operated to core a plurality of products while avoiding excess cuttings building up and jamming the cutter 162 and avoiding the need to disassemble the apparatus 150 to remove produce cuttings.

It will be apparent to those skilled in the art that the cutting guard 160 can have substantially any shape to provide protection from and for the cutter 162 including open rectangular, open triangular and substantially any other shape.

Further, a portion of the mouth 240 can be covered to provide additional protection to and from the cutter 162 while another portion remains open to allow extraction of the produce cuttings. For example, a first half 242 of a height 246 of the guard 160 can be covered while a second half 244 is open. In one embodiment, the cutter guard 160 simply comprises a plurality of posts extending between the support 164 and the press plate 154.

FIG. 9 shows an elevated view of a support plate 164 according to one embodiment of the present invention. In the embodiment shown in FIG. 9, the support plate 164 has generally “U” shaped gap 260 that has similar dimensions as an inner wall 248 of the cutting guard 160. As such, the cutting guard is positioned in contact with and aligned with the support plate 164. The support plate includes one or more support seats 262.

The support seats are configured to receive the one or more supports 166 and maintain the positioning of the supports relative to the support plate 164. The support seats 262 can be extensions from the surface 264 of the support plate or can be recesses within the surface of the support plate. Additionally, the support seats can be rivets or bolts extending through the support plate 164 to be received by the supports 166 to secure the supports with the support plate 164.

The support plate 164 shown in FIG. 9 has a generally triangular or “A” shape. However, the support plate can have substantially any shape that is capable of receiving the one or more supports 166 and maintaining the stability and positioning of the supports. Further, the gap 260 can be any shape that allows the shaft 210 to extend through the support plate 164. For example, the gap can be simply a round aperture just large enough through which the shaft passes.

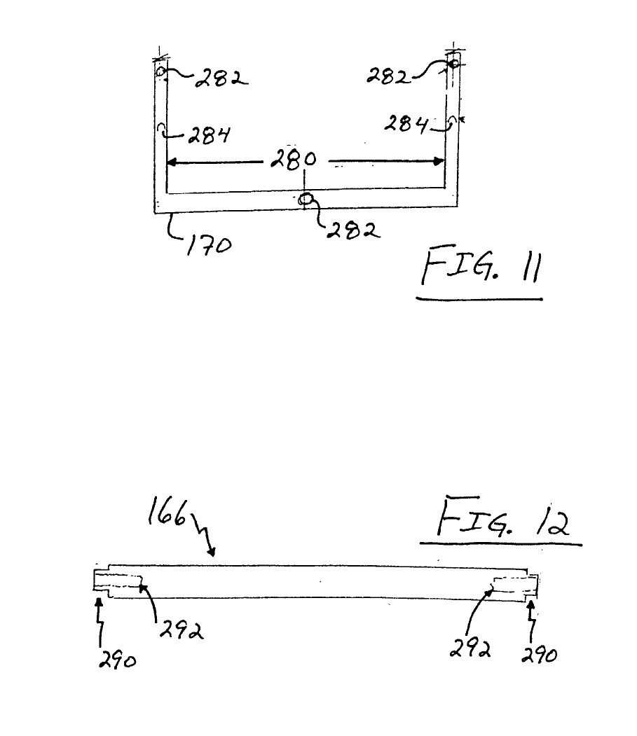

FIG. 10 depicts a simplified elevated view of the housing lid 178 according to one embodiment. The lid includes one or more support apertures 174 that allow the supports to extend through the lid 178 to be secured with the base support plate 170. The lid includes one or more linear motion flange mounts 271 for mounting the linear motion flanges 176. In one embodiment, the lid includes support aperture seals 270. The seals are secured to the lid and have an aperture with dimensions and shape similar to that of the supports 166 to prevent debris, dirt and dust from entering the housing 172. The lid 178 further includes a shaft aperture 272 that allows the shaft to extend out from the housing to the cutter 162.

In one embodiment, the lid additionally includes one or more extension resistance device mounts 274. These mounts 274 aid in securing the extension/compression resistance devices 184. The extension resistance mounts 274 can be implemented through any number of devices for mounting the extension resistance devices 184 depending on the type of extension resistance devices utilized. For example, the extension resistance mounts 274 can be simple apertures allow bolts to extend through to secure the extension resistance devices. The extension resistance mounts 274 can be hooks, rivets and substantially any other device for mounting. In one embodiment, the lid 178 can further include one or more apertures 276 for securing the shaft bearing/seal 218.

The lid 178 can have substantially any shape. Typically, the lid has a shape similar to the housing 172 to close off the housing preventing debris from getting into the housing. In one embodiment, the lid has a convex shape such that the center of the lid extends towards the cutter 162. As such, portions of the produce that are cored and fall onto the lid slide off and do not interfere with the motion of the support plate 164 and thus produce seat 152. Alternatively, the housing 17 and lid 178 can be configured at an angle such that the cored material slides off the lid.

FIG. 11 depicts a simplified elevated view of one embodiment of the base support plate 170. In the embodiment shown, the base support plate is generally “U” shaped. The mouth of the “U” shape has a sufficient width 280 to allow the base support plate 170 to move along the first axis 180 without contacting the motor 212 and any other components or devices within the housing 172. Other components can include wiring, hydraulic hoses, a control unit 286 (see FIG. 3) and other such components. The base support plate 170 includes one or more support mounts 282. The support mounts receive the supports 166 for mounting and securing the supports with the base support plate 170. In one embodiment, the base support plate additionally includes one or more expansion/compression resistance device mounts 282 for mounting and securing the expansion resistance devices 184 to the base support plate providing resistance to the movement of the base support plate 170 away from the lid 178 along the first axis 180. The base support plate 170 can have substantially any shape so that the base support plate avoids contacting other components within the housing that would hinder or prevent the movement of the base support plate along the first axis 180. In one embodiment, the base support plate 176 is positioned on the opposite side of the motor 212 as the lid 178. As such, the shape of the base support plant can be altered to potentially increase stability.

FIG. 12 shows a simplified cross-sectional view of a support 166 according to one embodiment of the present invention. The support can included mounting extensions 290 at either end of the support 166 to be received by the support seat 262 of the support plate 164 and the support mount 282 of the base support plate 170. The supports 166 can additionally include an inner bore 292 at each end. The bores 292 can be configured to receive a bolt, rivet or other device for securing the support with each of the support plate 164 and the base support plate 170. For example, the bore 292 can be threaded to receive a bolt screwed through the support plate and into the bore. Alternatively, the extensions 290 can be configured to extend through the support plate 166 and base support plate 170. One or more bores can extend into or through the supports 166 in a direction generally perpendicular to the bores 292 shown in FIG. 12. As such, the extensions 290 protrude beyond the support plate 166 or base support plate 170 to expose the perpendicular bores. The perpendicular bores can then receive rivets, bolts pins or other devices to secure the supports.

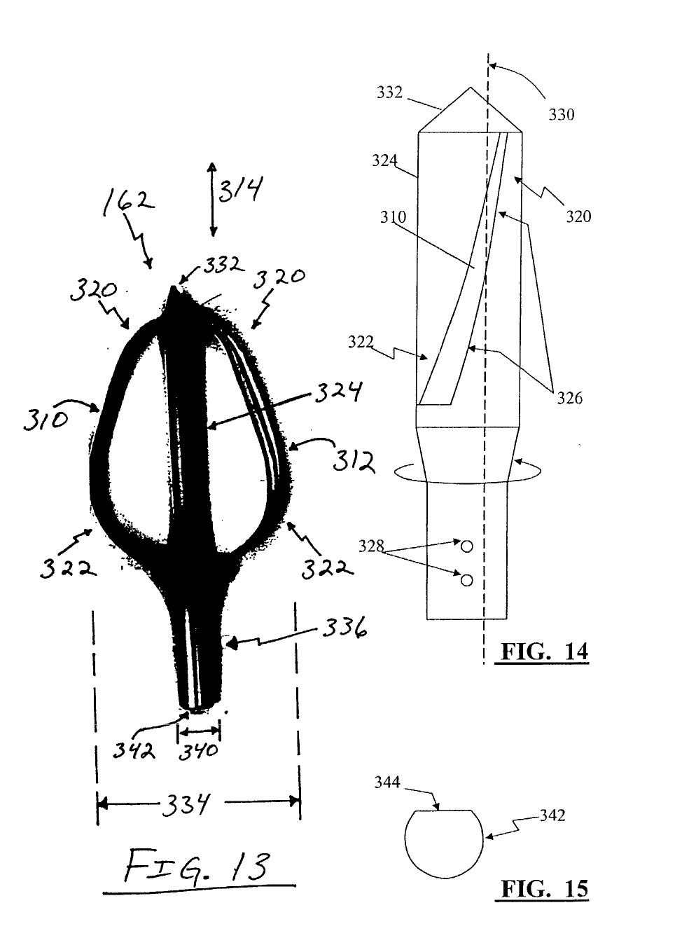

FIG. 13 depicts an elevated view of one implementation of a cutter 162 according to one embodiment of the present invention and FIG. 14 depicts a simplified block diagram of an elevated view of the cutter 162 perpendicular to the view shown in FIG. 13 according to one embodiment of the present invention. The example of the cutter shown in FIGS. 13 and 14 includes two blades 310 and 312, where the first blade 310 is shown with the cutting edge facing out of the page and the cutting edge of the second blade 312 is facing into the page. The blades 310,312 are configured such that during cutter rotation a first portion 320 of the blade 310, 312 crosses a plane 330 (see FIG. 14), for example a plane parallel with the paper and axis 314 in FIG. 13 (perpendicular to the paper in FIG. 14) prior to a second portion 322 of the blade crossing the plane. The width 334 of the cutter 162 is defined in one embodiment as the maximum distance 334 between cutting edges 326 of the two blades 310, 312. The width 334 can be configured to be substantially any size to provide accurate coring of the produce. The shape of the cutter can additionally be substantially any shape to achieve the desired coring.

Still referring to the embodiment shown in FIGS. 13 and 14, the blade 310 extends along a center support 324. The cutting edge 326 of the first portion 320 of the blade 310 crosses the plane 330 prior to the cutting edge of the second portion 322. In one embodiment, each blade 310,312 is slightly twisted from a plane parallel with and aligned with both blades 310, 312 such that the first portion 320 of the blades cross the plane prior to the second portion 322. In one embodiment, the blades have a helix shape where the distance between cutting edges 326 of each blade is the largest diameter of the cutter. As one example, the blade can be configures similar to a spade drill.

In one embodiment, the cutter 162 includes a point 332 that extends from the center support 324. The point 332 can be a continuous portion of the center support or can be a separate unit that is secured with the center support. The point is provided, at least in part, to initially contact the produce during coring to initiate penetration into the produce.

A mounting post 336 extends from the center support 324 to secure the cutter 162 with the shaft 210. The mounting post 336 can be a continuous portion of the center support or can be a separate unit secured to the center support 324 and blades 310,312. In one embodiment, the mounting post 336 has a diameter 340 that is less than a bore diameter 366 (see FIG. 16) of the shaft 210 or extension shaft 216.

As such, the mounting post is inserted within the shaft bore 360. The mounting post 336 includes one or more bores 328 extending into the mounting post to receive bolts, rivets, pins or screws that are screwed through matching apertures 364 formed within the shaft 210 to secure the cutter 162 with the shaft.

FIG. 15 shows a cross-sectional view of a base 342 of the mounting post 336 according to one embodiment of the present invention. The base can include a flat portion 344. The flat portion 344 mates with a flat portion of a bore 360 within the shaft 210 to aid in stability and alignment, holds the cutter in position, and drives the cutter providing improved rotational torque to the cutter 162 by the shaft 210. Set screws can be used to secure and locate the cutter with the shaft and aid in driving the cutter.

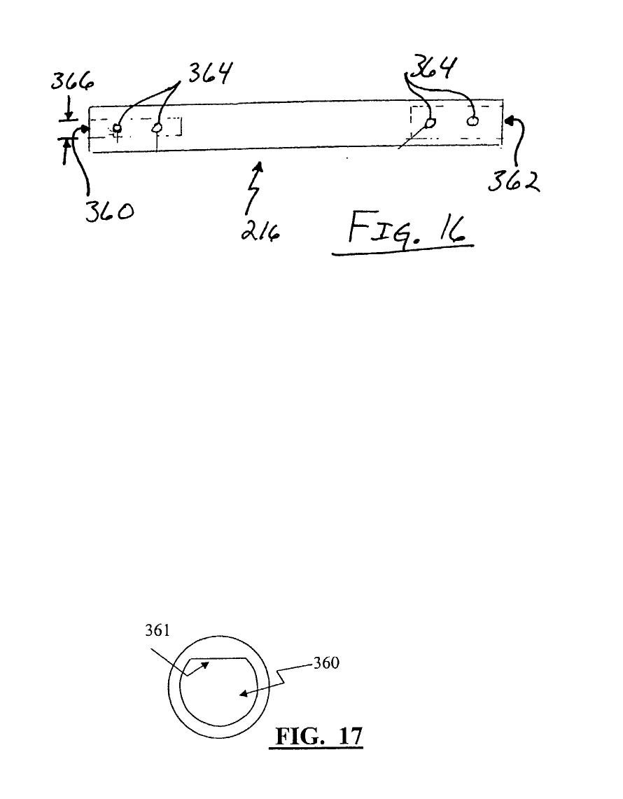

FIG. 16 depicts a plain view of the extension shaft 216 according to one embodiment of the present invention. The extension shaft includes a first bore 360 for receiving and securing the mount post 336 of the cutter 210. FIG. 17 shows one embodiment of a cross-sectional view of the extension shaft 216 and first bore, where the first bore includes a flat portion 361 to engage the flat portion 344 of the cutter 162. Referring back to FIG. 16, the extension shaft 216 additionally includes a second bore 362 for mounting and securing to the motor shaft 214. The extension shaft can include one or more securing apertures 362 in one or both of the bores 360, 362 to allow a bolt, rivet or other securing device to be passed through to contact the mounting post 336 or motor shaft 214. In one embodiment, the securing apertures 364 match with securing apertures 338 within the mounting post 336 and/or motor shaft 214 such that a bolt, pin, rivet or the like mates with and secures the mounting post and/or motor shaft.

Referring back to FIG. 3, the apparatus 150 typically includes a plurality of supports 166, for example three supports distributed over an area of the support 164 and lid 178 of the housing 172. Typically the supports are substantially parallel and axially aligned with the first axis 180. The supports are also substantially parallel with the shaft 210. Typically, the supports are equally distributed about the support 164 providing stability and equal distribution of pressure.

The pieces or sub-units of the apparatus 120, 150, such as the produce seat 152, press plate 154, seat supports 156, cutter guard 160, cutter 162, support plate 164, supports 166, base support plate 170, housing 172, linear motion flanges 176, lid of the housing 178 and other sub-units or pieces can be constructed from one or more of substantially any material including plastic, aluminum, steel, steel alloy, tin, iron, titanium and substantially any other material or combination of materials capable of providing the rigidity and stability needed to operate the apparatus 150 and core produce. The pieces do not have to all be constructed of the same material, for example, the produce seat can be plastic while the shaft and cutter are constructed from steel or a steel alloy.

The pieces or sub-units can be secured together through substantially any method for securing, including rivets, bolts, welding, epoxy, resin, press-fit, snap-fit, hook-and-loop, tongue-and-groove and substantially any other method for securing. Typically, several different methods for securing are utilized in constructing the apparatus 120, 150, for example, the produce seat 152 may be welded with the cutter guard 160, and the supports 166 are secured with the support plate 164 with bolts. In some embodiments, more than one method for securing is utilized to secure two pieces. For example, both an epoxy and a bolt can be used to secure the support 166 with the support plate 164.

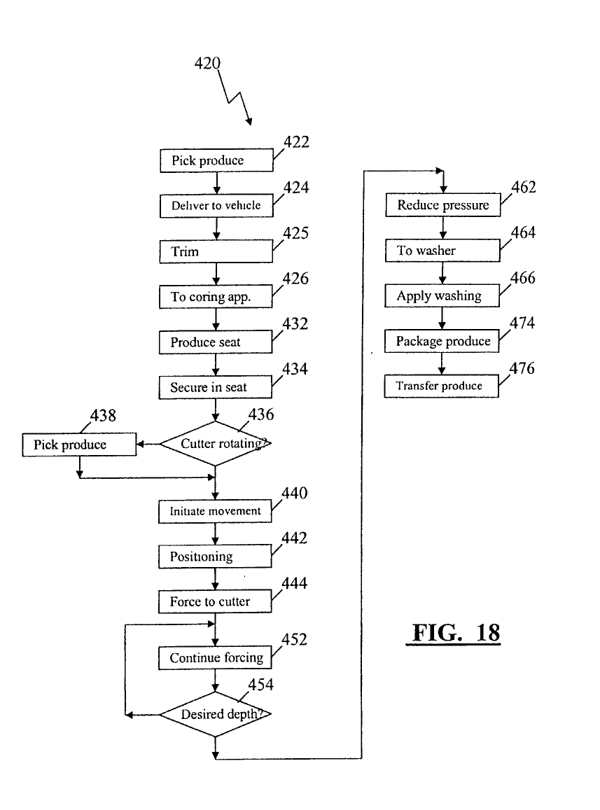

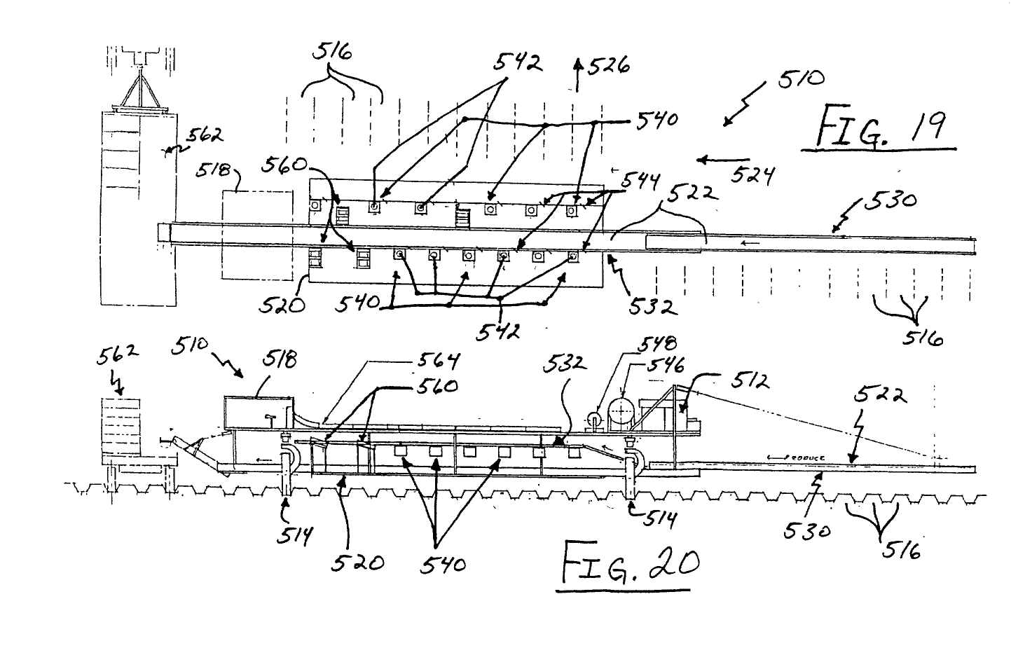

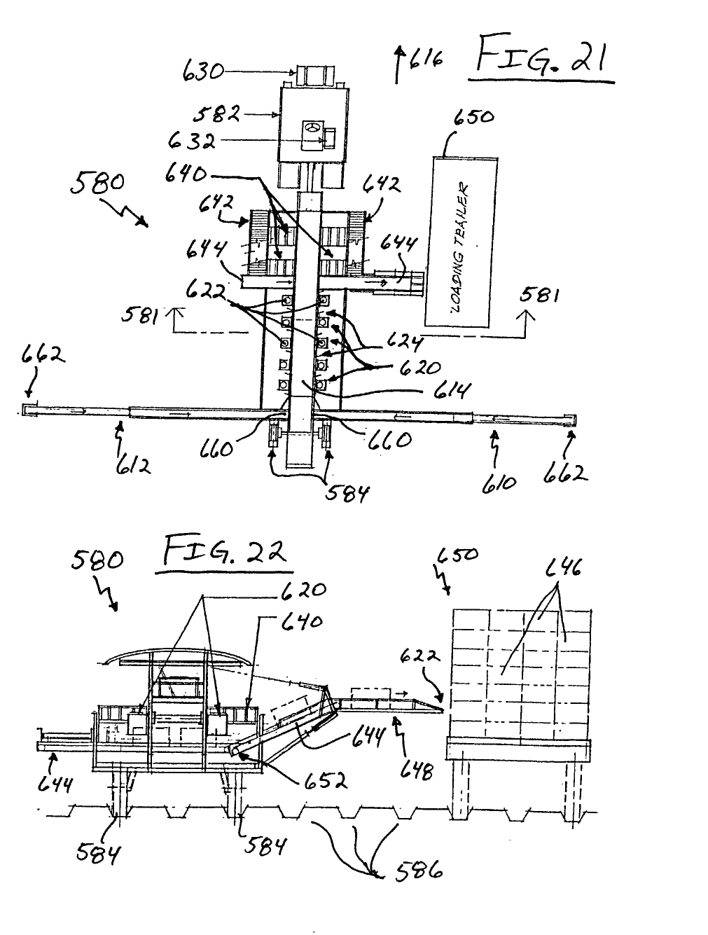

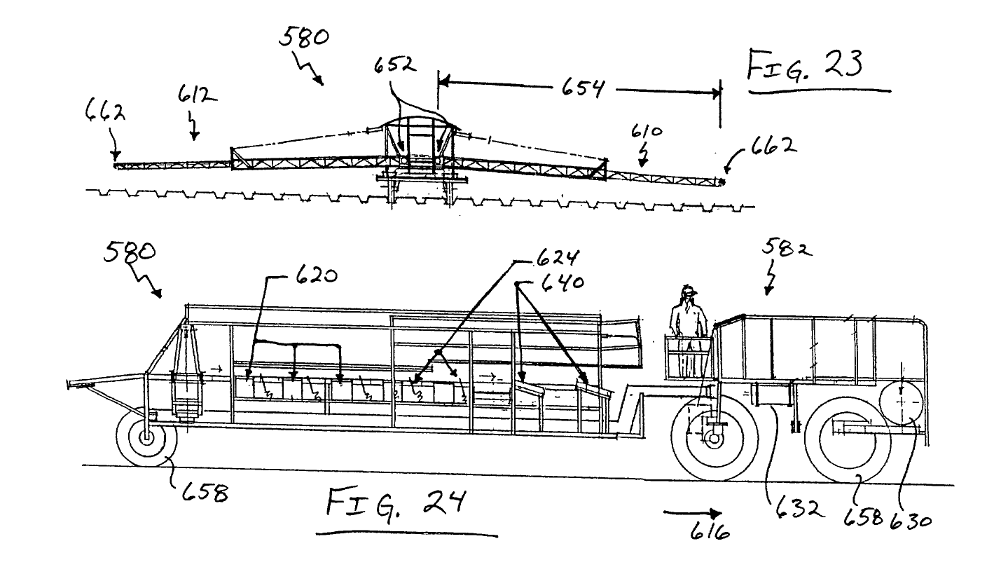

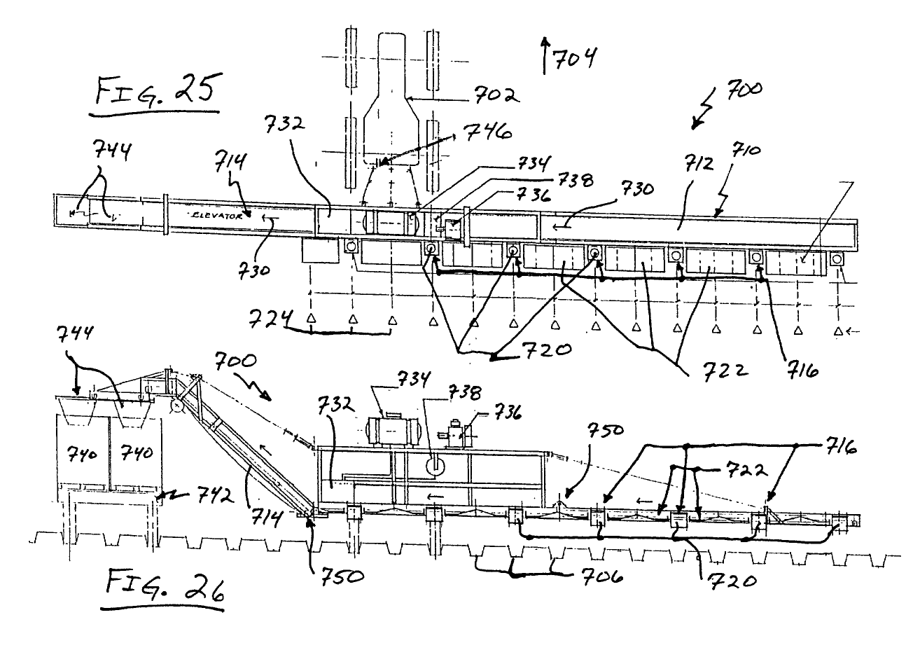

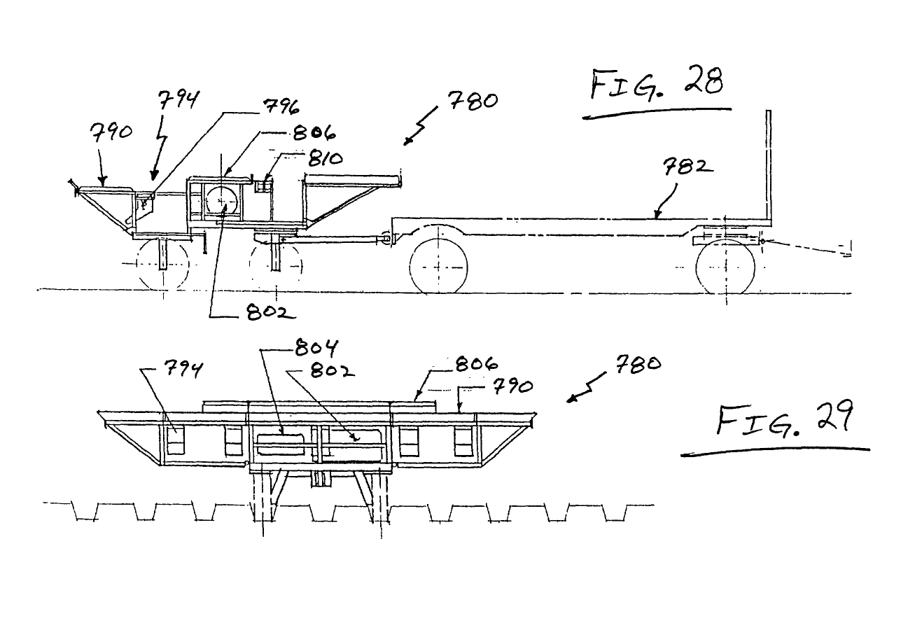

FIG. 18 depicts a simplified flow diagram of a process 420 for harvesting and preparing produce for shipment. In step 422, a picker or a machine picks or harvests the produce 122. In step 424, the produce is delivered to a processing or harvesting vehicle 510 (see FIG. 19, additionally see FIGS. 20-29). In one embodiment of the process 420, the produce is trimmed or cut to remove excess stock, stem, leaving and other unwanted portions of the produce in step 425. In step 426, the produce is delivered to a coring apparatus operator or to the coring apparatus 150. In step 432, the produce is deposited into the produce seat 152 with the section of the produce to be cored positioned and aligned with the cutter aperture 186 of the produce seat such that the section of the produce to be cored is facing and in alignment with the cutter 162. In step 434, the produce is secured within the produce seat. In one embodiment, the operator simply applies pressure on produce.

In step 436, it is determined if the cutter is rotating. If the cutter is not rotating, the process proceeds to step 438 where rotation of cutter is initiated. If the cutter is rotating in step 436 and following step 438, the process 420 proceeds to step 440 where movement of the produce and produce seat towards the cutter is initiated, for example, by the operator applying pressure to the press plate 154. In one embodiment, steps 438 and 440 are a single step where applying pressure on the pressure plate initiates rotation of the cutter 162.

In step 442, the positioning of produce is maintained within the seat by the operator apply pressure on the produce. In step 444, the movement of the produce seat and produce towards the cutter is continued such that the produce is caused to contact the cutter. In step 452, the movement of the produce is continued forcing the produce onto the cutter to core the produce to a desired penetration depth 146 (see FIG. 2), for example, continuing to apply pressure on the press plate while maintaining positioning of the produce within the seat. In step 454, it is determined if the produce is completely cored. For example, it is determined if the support plate 164 has contacted the stops 192 and thus the cutter has extended into the produce to a desired depth. If the produce is not completely cored, the process returns to step 452 where pressure is continued to be applied on the press plate. If, in step 454, the produce is cored, the process proceeds to step 462.

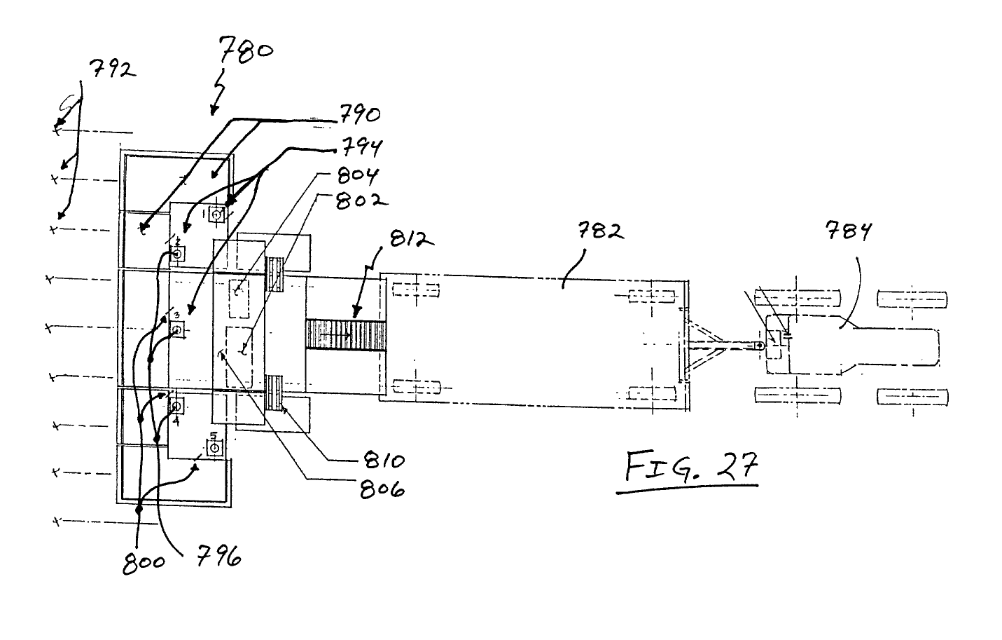

In step 462, the pressure on press plate is released or reduces to allow the produce seat and produce to retract away from cutter. In step 464, the cored produce is washed, for example by the operating using a pressure hose delivering a washing solution or transferring the produce to a washer or washing system 732 (see FIGS. 25 and 26). In one embodiment, the cored produce is placed on a conveyer belt that passes the cored produce through the washing system. In step 466, a washing agent is applied to the produce. For example, a stream of cleaning solution is sprayed over the produce. For example, the cleaning solution can include a mixture of water and Chlorine in a concentration of 20 to 500 part per million (ppm), preferably a concentration of 30 to 100 ppm, and more preferably 50 to 70 ppm.

In step 474, the cored produce is packaged for shipment. In one embodiment, packaging includes wrapping and/or boxing the cored produce. In step 476, the packaged produce is transferred from the fields where it was harvested to a customer for use or sale, or transferred to a processing plant for further processing.

FIGS. 19 and 20 depict an elevated view and a cross-sectional view, respectively, of an agricultural harvesting vehicle 510 according to one embodiment of the present invention. Typically, the harvesting vehicle 510 includes an engine 512 to provide self propulsion. The engine 512 couples with a drive shaft (not shown) that further couples with and causes rotation of one or more motion or movement devices such as wheels or track belts 514. The wheels are spaced to fit within furrows 516 of a plowed field so as not to disturb or damage the furrows 516 and crops growing in the fields. The wheels 514 are additionally fixed with and support a rigid frame 520 that provides structure and support for the vehicle 510. A vehicle operator is positioned in an operator platform 518 to steer and control the speed of the vehicle.

The frame 520 supports one or more continuous belts or conveyors 522. The conveyors extend along an axis 524 that is generally perpendicular to the vehicle's direction of travel indicated by an arrow labeled 226. The conveyors can be formed from rubber, canvas, leather, metal gratings, links and the like, and can be a sold piece, can be meshed of have other structure. Individuals or pickers picking the produce being harvested travel or walk along the direction of travel 226 behind a first portion of the conveyor 530 that extends out and away from the frame 520. The pickers cut or pick the produce and place the produce onto the first portion of the conveyor 530. The conveyor 522 carries the produce to the vehicle to pass between one or more processing stations 540. Typically, each processing station includes a coring apparatus 542, which can be similar to the coring apparatuses 120, 150 as described above (see FIGS. 1-17). The one or more coring apparatuses are typically secured or mounted on the frame 520, usually through the housing 172 of the apparatus 150, to maintain the positioning and stability of the coring apparatus.

As the picked produce travels along a second portion of the conveyor 532 between processing stations 540, coring operators operating the coring apparatuses 542 retrieve the produce from the conveyor and insert the produce into the coring apparatus 542 with the portion of the produce to be cored aligned with and facing the cutter. The coring operators depress the produce seat and produce to contact the cutter causing the extraction of the core. In one embodiment, the processing stations 540 additionally include a sprayer or washing wand 544. The washing wand 544 is coupled through hosing (not shown) to a fluid or wash tank 546. The wash tank delivers a washing solution, for example a solution of Chlorine and water, to the sprayers 544. In one embodiment, an air compressor/tank 548 pressurizes the washing solution to force the solution to the sprayers. The air and water washing system provides an even application of the cleaning solution. The operators spray the produce with the washing solution to clean the produce. Alternatively, a plurality of sprayers can be positioned above and/or below the conveyor 522 (for example, at the transition between the first and second portions of the conveyor 530, 532) to wash the produce prior to or after the operators retrieve the produce for coring.

The cored and cleaned produce is then returned to the second portion of the conveyor 532 where the produce is retrieved by one or more packers at one or more packer stations 560. The packers package the cored and washed produce, for example, inserting the produce into boxes, and in some embodiments, wrap the produce prior to being arranged within the boxes. The packers place the packed boxes back onto the conveyor 522 where it is received by a loading trailer 562. When the loading trailer 562 is full, it pulls away from the harvesting vehicle 510 to transport the cored produce away from the fields and allows another loading trailer to be positioned to receive the loaded boxes of harvested and cored produce.

In one embodiment, the operator platform 518 is additionally configured to allow one or more box assemblers to be positioned. The box assemblers assemble boxes or carts and forward the boxes along a box rack 564. The box rack 564 is positioned on the vehicle 510 to allow the packers to retrieve empty boxes to fill with the cored produce.

In one embodiment, the vehicle operator additionally controls the speed of the conveyor 522 to avoid uncored produce from passing all of the processing stations 540. In one embodiment, the first portion of the conveyor 530 is hinged at approximately an intersection between the first and second sections 530, 532 of the conveyor to allow the first portion to be raised to avoid obstacles and roads, or for other reasons.

FIGS. 21,22,23 and 24 depict an elevated view, a cross-sectional view along an axis 581, a rear elevated view and a side elevated view, respectively, of a harvesting vehicle 580 according to one embodiment of the present invention. The vehicle 580 is removably attached with a motorized vehicle 582, such as a tractor or other vehicle capable of pulling the harvesting vehicle 580. Alternatively, the harvesting vehicle 580 can include and engine coupled with a drive shaft that drives one or more movement devices, such as wheels 584, to move the vehicle 580 through the fields. The wheels are spaced to fit between furrows 586 so as not to damage unpicked produce and the furrows. An operator is positioned on the tractor 582 or an operator platform if the vehicle 580 includes an engine for self propulsions.

The vehicle includes one or more lateral conveyors 610 and 612. A first and second conveyor 610,612 extend out from the vehicle 580 generally perpendicular to the direction of travel of the vehicle indicated by arrow 616. The conveyors 610, 612 continuously loop in a direction towards the vehicle. Pickers travel in the direction of travel behind the conveyors and pick the produce. The pickers place the produce onto the conveyor where the produce is delivered to a central conveyor 614. The central conveyor loops in the direction of travel moving the picked produce in the direction of travel to pass one or more processing stations 620. In the embodiment shown in FIG. 21 there are 10 processing stations 620. However, it will be apparent to one skilled in the art that any number of processing stations can be included to maximize efficiency of harvesting. Typically, each processing station includes a coring apparatus 622 that is similar to the coring apparatuses 120, 150 previously described (see FIGS. 1-17). A coring operator is positioned at each processing station 620. The coring operators retrieve produce from the central conveyor 614 and position the produce over the cutter aperture proximate the cutter with the portion of the produce to be cored facing the cutter. The coring operator causes the produce to contact the cutter causing the cutter to core the produce.

In one embodiment, the vehicle includes one or more washing devices or wands 624 at each processing station 620 or between every other processing station to be shared by two coring operators. The coring operator washes the produce, either before or after coring. Hoses (not shown) couple between the washing wands 624 and a washing solution tank 630 to carry washing solution to the wash wands. In one embodiment, one or more hoses additionally couple between an the washing solution tank 630 and an air tank and/or compressor 632 to pressurize the washing solution to deliver the washing solution to the washing wands.

In one embodiment, the vehicle 580 includes a washing device (not shown). For example, the washing device can be positioned at the junction of the first and second lateral conveyors 610,612 with the central conveyor 614. The washing device washes the produce prior to delivery to the coring operators. The washing device can include a plurality of sprays, a bath, a combination of spray and bath or other such configurations for washing.

Once the produce is cored and washed, the coring operators return the cored produce to the central conveyor 614. The central conveyor continues to carry the produce in the direction of travel 616 to one or more packaging stations 640. Typically, a packager is positioned at each packaging station. The packagers retrieve the cored produce from the central conveyor 614 and package the produce in cartons or boxes. Once a carton is full, the packager places the full carton 646 onto a track, conveyor or series of rollers 642. The rollers 642 deliver the full carton to a third lateral conveyor 644 or another track or series of rollers. The third lateral conveyor 644 forwards the full cartons to a loading trailer or vehicle 650. In one embodiment the third lateral conveyor 644 includes an elevated portion 648 that elevates the full cartons 646 to be delivered to the loading vehicle 650. Once the loading trailer is full with full cartons, the loading trailer pulls way from the harvesting vehicle 580 to allow another loading trailer to be positioned proximate the third lateral conveyor 644 to receive full cartons.

In one embodiment, the first, second and third lateral conveyors 610,612 and 644 are hinged 652 to allow first ends 662 of the conveyors to be lifted to avoid obstacles. In one embodiment, the first and/or second lateral conveyors 610, 612 are segmented to allow the length 654 of the conveyor to be increased or decreased by extending or retracting the first ends 662 of the conveyors away from or towards second ends 660 of the conveyors secured with the vehicle 580. The first, second and third lateral conveyors 610, 612, and 644 are typically detachably secured with the frame of the vehicle 580 to allow one or all of the conveyors to be removed.

FIGS. 25 and 26 depict an elevated view and a cross-sectional view, respectively, of a harvesting vehicle 700 according to one embodiment of the present invention. The harvesting vehicle 700 is removably secured to a tractor or other motorized vehicle 702 for pulling the harvesting vehicle 700 in a direction of travel indicated by an arrow labeled 704. The direction of travel is parallel with furrows 706 of the field being harvested. The harvesting vehicle can be secured with the tractor 702 through substantially any coupling including a three-point hitch or other such coupling.

The harvesting vehicle 700 includes a conveyor 710. The conveyor typically is positioned generally perpendicular to the direction of travel 704. The harvesting vehicle 700 additionally includes one or more coring stations 716. The coring stations 716 are disburse along a first section 712 of the conveyor 710. Each coring station 716 includes a coring apparatus 720. The coring apparatus is similar to the coring apparatus 120, 150 as described above (see FIGS. 1-17).

Picker tables 722 are additionally disbursed along the first section 712 of the conveyor. Pickers or individuals cutting the produce, represented by triangles labeled 724, follow the harvesting vehicle 700 picking produce. The pickers 724 place the cut produce onto the picker tables. In one embodiment, the pickers additionally trim the cut produce to remove extraneous portions of the cut produce. Typically, a coring operator is positioned at each coring station 720. The coring operators take cut produce from the cutting table and position the produce in the coring apparatus. In one embodiment, the coring operator secures the produce within the coring apparatus with the portion of the produce to be cored proximate a cutting device or blade of the coring apparatus 720. The coring operator initiates coring by moving the produce to contact the cutting device. The coring operator continues to move the produce onto the cutting device until the cutting device extends into the produce to a desired depth. The coring operator then places the cored produce onto the conveyor 710.

The conveyor carries the produce in a direction signified by arrows labeled 730 to pass through a washing unit 732. The produce passes through the washing unit and is washed with a washing solution. The washing solution can be water, water and Chlorine or other washing solutions. In one embodiment, the washing unit includes a plurality of pressure nozzles that spray the cored produce with the cleaning solution. Alternatively or additionally, the cored produce is passed through a cleaning solution bath. In one embodiment, the cleaning solution sprayed over the cored produce is collected and recycled through the washing unit to be reused to spray additional cored produce.

The washing unit is coupled through hoses (not shown) to a cleaning solution tank 734 that stores the cleaning solution (and, in one embodiment, recycled cleaning solution). An air compressor 736 stores air in a pressurized air tank 738. The air tank is coupled through hoses to the cleaning solution tank 734 and the washer unit 732 to provide pressure to force the washing solution from the sprayers.

Following the washing unit 732, the conveyor 710 forwards the cored and washed produce to a second elevated section 714 of the conveyor 710. The second section 714 carries the cored and washed produce to an elevation greater than one or more collection bins 740 positioned on a loading trailer 742. The second section 714 of the conveyor terminates in dispensers 744 at the bins to drop the cored and washed produce into the bins 740.

In one embodiment, a hydraulic power source 746 is included on the harvesting vehicle 700 or tractor 702. The power source 746 couples with the coring apparatus 720, compressor 736, pumps (not shown) for recycling cleaning solutions and other devices on the vehicle 700 utilizing power.

Typically, the first and second sections of the conveyor 712, 714 are removably secured with the harvesting apparatus 700. Further, the first and second sections of the conveyor are secured with the harvesting apparatus 700 through hinges 750. The hinges allow the first and second sections to be elevated to avoid obstacles and for storage. Additionally, the hinging on the second section 714 of the conveyor 710 allows the second section to be elevated to one of a plurality of heights to accommodate any number of different heights of loading trailers 742 and/or bins 740.

FIGS. 27-29 show an elevated view, cross-sectional view and a rear view, respectively, of a harvesting apparatus 780 according to one embodiment of the present invention. The harvesting vehicle 780 is removably secured with a loading vehicle or trailer 782. The loading vehicle can include an engine for propelling the loading vehicle 782 and harvesting vehicle 780, or the loading vehicle can be further removably secured with a tractor 784 or other vehicle capable of pulling both the harvesting vehicle 780 and loading vehicle 782. In one embodiment, the harvesting vehicle includes an engine for providing self propulsion for the harvesting vehicle such that the harvesting vehicle simply follows the loading vehicle 782.

The harvesting vehicle 780 includes one or more picker tables 790. Pickers or individuals cutting the produce 792 follow the harvesting vehicle 780 and pick or cut produce. The pickers place the cut produce onto the picker tables 790. In one embodiment, the pickers cut extraneous and unwanted portions off of the cut produce. The harvesting vehicle 780 further includes one or more coring stations 794. Each coring stating 794 includes a coring apparatus 796. The coring apparatuses can be similar to the coring apparatus 120, 150 as described above (see FIGS. 1-17).

Coring operators are positioned at the coring apparatuses 796 and retrieve picked produce from the picker table 790. The produce is positioned in the coring apparatus 796 and cored by forcing the produce onto a cutting device or blade. In one embodiment, the coring stations additionally include wash sprayers 800. The wash sprayers couple through hoses (not shown) to a cleaning solution tank 802. An air tank and/or compressor 804 couples with the solution tank 802 and/or sprayers to provide pressure to the sprayers.

The cored produce is placed on a cored produce table 806. One or more packing stations 810 are positioned proximate the produce table. One or more packing operators are positioned at the packing stations. The packing operators retrieve the cored produce from the produce table 806 and package the produce into crates. Once the crates are full, the packing operators transfer the crates to a conveyor, track, slide, series of rollers or other device for moving the full crates 812. The series of rollers 812 are positioned on the harvesting vehicle 780 such that the full crates are transferred towards the loading vehicle 782. On the loading vehicle, loaders transfer and arrange the full crates to the loading vehicle 782.

The coring apparatus 120, 150 of the present invention can be implemented on a harvesting vehicle to provide processing of the produce prior to the produce being transported to a processing plant, vendor or distributor. The coring apparatus can be a stand alone device transportable to a location, such as fields being harvested. Picked produce can be delivered to the stand alone coring apparatus where it can be cored. The coring apparatus 120, 150 can be implemented in a processing plant as part of produce preparation for shipment. The apparatus can also be implemented in a processing assembly that prepares produce for distribution and sales. For example, a company selling frozen vegetables can implement the coring apparatus in an assembly line preparing produce to be processed and prepared for freezing.

The coring apparatus and method of the present invention reduces the amount of damage produce experiences during processing. The present method and apparatus additionally improves the quality of the produce by being able to process the produce in the fields. Further, the present invention provides accurate coring to optimize the amount of usable produce.

While the invention herein disclosed has been described by means of specific embodiments and applications thereof, numerous modifications and variations could be made thereto by those skilled in the art without departing from the scope of the invention.

What is claimed is:

1. An apparatus for coring produce, comprising:
a produce seat having a cutter aperture, wherein the produce seat is configured to receive produce to be cored such that the portion of the produce to be cored is positioned and aligned with the cutter aperture;
a cutter is secured with a shaft, the shaft being rotationally coupled with a motor configured to cause the shaft and cutter to rotate, wherein the cutter is aligned with the cutter aperture; and
a support being configured to position the produce seat such that the produce seat is positioned proximate the cutter and the cutter aperture is aligned with the cutter, wherein the support is configured to allow the produce seat to be moved from a first position where the produce seat is proximate the cutter, to a second position such that at least a portion of the cutter extends through the cutter aperture, and to allow the produce seat to be returned to the first position.

2. The apparatus for coring produce as claimed in claim 1, further comprising:
a cutter guard secured between produce seat and the support positioning the produce seat relative to the cutter as dictated by the positioning of the support, wherein the cutter guard at least partially surrounds the cutter when the produce seat is in the first position.

3. The apparatus for coring produce as claimed in claim 1, further comprising:
a compression/extension resistance device configured to resist the movement of the produce seat from the first position to the second position and to return the produce seat from the second position to the first position.

4. The apparatus for coring produce as claimed in claim 1, further comprising:
a press plate secured with the produce seat, the press plate having a cutter aperture aligned with the cutter aperture of the produce seat, such that the cutter extends through both the cutter aperture of the press plate and the cutter aperture of the produce seat when the produce seat is in the second position.

5. The apparatus for coring produce as claimed in claim 1, further comprising:
a housing configured to position the support;
a frame supported by one or more movement devices for allowing movement of the frame over fields to be harvested, wherein the housing is secured with the frame.

6. The apparatus for coring produce as claimed in claim 5, further comprising:
a conveyor supported by the frame and positioned on the frame proximate the produce seat, such that harvested produce is carried by the conveyor towards the produce seat.

7. The apparatus for coring produce as claimed in claim 1, wherein:
the cutter includes a blade positioned on a center support, wherein the blade is configured such that a first portion of a cutting edge of the blade contacts the produce during coring prior to a second portion of the cutting edge contacting the produce.

8. An apparatus for processing harvested produce, comprising:
a motor rotationally coupled with a shaft at a first end of the shaft;
a cutter being secured to a second end of the shaft such that the cutter rotates as the shaft rotates;
a produce seat having a cutter aperture, wherein the produce seat is movable along an axis such that in a first position the produce seat is proximate the cutter and the cutter does not extend through the cutter aperture, and in a second position the cutter at least partially extends through the cutter aperture.

9. The apparatus as claimed in claim 8, further comprising:
a housing configured to house the motor and a base support plate;
the housing having a lid such that the shaft extends through the lid to couple with the cutter;
one or more supports being secured with the base support plate at a first end of the one or more supports such that the one or more supports extend from the base support plate through the lid;
the one or more supports being secured with a support plate at a second end of the one or more supports;
a cutter guard being secured with and between the support plate and the produce seat, wherein the cutter guard at least partially surrounds the cutter when the produce seat is at least in the first position.

10. The apparatus as claimed in claim 9, further comprising:
one or more extension/compression resistance devices secured between the housing and the base support plate to resist the movement of the produce seat from the first position to the second position and to provide a return force to return the produce seat from the second position to the first position.

11. The apparatus as claimed in claim 8, further comprising:
a frame supported by one or more movement devices to provide movement of the frame over produce to be harvested, wherein the motor and produce seat are supported by the frame.

12. A harvesting vehicle for harvesting produce, comprising:
a frame supported by one or more movement devices, wherein the frame provides rigidity and structure to the harvesting vehicle;
one or more processing stations having a coring apparatus, wherein the coring apparatus comprises:
a produce seat having a cutter aperture, where in the produce seat is configured to receive produce such that a portion of the produce to be cored is aligned with the cutting aperture;
a cutter aligned with the cutter aperture; and
one or more supports configured to provide positioning of the produce seat, such that in a first position the cutter does not extend through the cutter aperture and in a second position the cutter extends at least partially through the cutter aperture.

13. The harvesting vehicle as claimed in claim 12, further comprising:
a first conveyor supported by the frame such that the first conveyor is positioned on the frame proximate the one or more processing stations, such that the first conveyor carries produce towards the one or more processing stations.

14. The harvesting vehicle as claimed in claim 13, further comprising:
a second conveyor supported by the frame and extending out from the frame and over a field being harvested, such that the second conveyor carries produce to the first conveyor.

15. The harvesting vehicle as claimed in claim 13, further comprising:
a washing system positioned over the first conveyor, the washing system being configured to deliver a washing solution to contact the produce carried on the first conveyor.

16. A method for coring produce, comprising the steps of:
positioning the produce in a produce seat;
aligning the produce with a cutter aperture of the produce seat;
forcing the produce seat and produce towards the cutter;
causing the cutter to contact the produce;
continuing to force the produce onto the cutter until a desired penetration of the cutter into the produce is achieved providing a cored produce;
forcing the cored produce away from the cutter; and
removing the cored produce from the produce seat.

17. The method as claimed in claim 16, further comprising the step of:
transporting the cored produce away from a field from which the produce was harvested following the step of removing the cored produce from the produce seat.

18. The method as claimed in claim 16, further comprising the steps of:
picking the produce;
placing the produce on a conveyor of a harvesting vehicle; and
retrieving the produce from the conveyor prior to the step of positioning the produce in a produce seat.

19. The method as claimed in claim 16, further comprising the step of directing a spray of washing solution from a washing wand at the produce and washing the produce.

20. The method as claimed in claim 16, wherein the step of continuing to force the produce onto the cutter includes continuing to force the produce onto the cutter until a stop is contacted.

21. An apparatus for processing harvested produce, comprising:
means for receiving and maintaining produce, the means for receiving and maintaining the produce including an aperture;
means for cutting aligned with the aperture;
means for rotating being secured with the means for cutting, such that the means for rotating rotates the means for cutting;
means for supporting the means for receiving and maintaining the produce, wherein the means for supporting allow movement of the means for receiving and maintaining such that in a first position the means for cutting is not protruding through the aperture, and in a second position the means for cutting at least partially extends through the aperture; and
means for resisting movement of the means for receiving and maintaining from the first position to the second position.

22. The apparatus as claimed in claim 21, further comprising:
means for receiving pressure from an operator secured with the means for receiving and maintaining the produce.

23. The apparatus as claimed in claim 21, further comprising:
means for transporting the means for receiving and maintaining, the means for rotating, the means for supporting and the means for resisting across a field to be harvested.
